(19) United States
(12) Patent Application Publication
(10) Pub. No.: US 2003/0161238 A1
(43) Pub. Date: Aug. 28, 2003

(54) Optical disk recording and/or reproducing apparatus, and recording and/or reproducing method

(76) Inventor: Nobuyuki Oka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/311,220

(22) PCT Filed: May 27, 2002
(86) PCT No.: PCT/JP02/05118

(30) Foreign Application Priority Data
May 30, 2001 (JP) 2001-162378

(51) Int. Cl. G11B 7/00

(52) U.S. Cl. 369/53.18; 369/53.3

(57) ABSTRACT

This invention provide a recording/reproducing device for a recordable optical disc. The recordable optical disc has a management data area in which data related to intrinsic physical characteristics and data related to linear recording density are recorded, and a data recording area in which recording data is recorded. A rotational driving unit rotationally drives the optical disc and has a speed detection unit for detecting rotation of the optical disc. A temperature detection unit detects the temperature on the periphery of the optical disc. A control unit calculates optimum power of a laser beam cast onto the optical disc on the basis of the data related to intrinsic physical characteristics and the data related to linear recording density which are read out by a head unit, detection data from the speed detection unit, and detection data from the temperature detection unit, and control the head unit on the basis of the result of the calculation.

### TECHNICAL FIELD

This invention relates to a recording and/or reproducing device and a recording and/or reproducing method using a recordable optical disc as a recording medium. Particularly, it relates to a recording and/or reproducing device and a recording and/or reproducing method in which power of a laser beam cast for recording or reading information to or from an optical disc is optimized, thus enabling accurate and secure recording of information.

### BACKGROUND ART

Conventionally, magneto-optical recording media such as magneto-optical discs are used as recording media for information such as audio data and video data. A magneto-optical recording medium of this type has a magneto-optical recording film as a recording film. The magneto-optical recording film used in this case is a magnetic thin film with its coercive force Hc reduced by increase in temperature. By casting a laser beam with an intensity necessary for recording while supplying a vertical magnetic field as a weak external magnetic field, and then causing magnetization reversal in the part of the magneto-optical recording film where the laser beam is cast in accordance with an external magnetic field, recording of information to the magneto-optical recording medium is carried out.

In this case, a temperature profile for recording proper to the magneto-optical recording medium is associated with physical characteristics such as the composition and thickness of the recording film formed in the magneto-optical recording medium and the material of a protection film provided to cover the recording film. The physical characteristics of the magneto-optical recording medium is influenced by conditions in transferring a recessed and protruding pattern provided on a master board, a mother board, a stamper and the like used for preparing the magneto-optical recording medium and film forming conditions.

In a conventional recording device for the magneto-optical recording medium, data related to the output level or intensity of a laser beam that is optimum for the intrinsic physical characteristics of the magneto-optical recording medium, and correction data related to the output level or intensity of a laser beam that is optimum for the atmospheric temperature in the device for the magneto-optical recording medium are stored in advance in a register provided in the device. The data stored in the register is read out from the register when recording information to the magneto-optical recording medium. The irradiation power of a laser beam for recording is set on the basis of these data and it is corrected in accordance with rise in temperature in the device.

In a more recent magneto-optical recording device, the speed of recording operation is increased and recording is carried out at a high rotational speed that is twice, four times or eight times the standard rotational speed of a magneto-optical disc as the magneto-optical recording medium. Although the linear velocity changes depending on the linear recording density of the magneto-optical recording medium, correction of the irradiation power of a laser beam in the case of recording at a high rotational speed that is twice, four times or eight times the standard rotational speed of the standard magneto-optical disc and correction of the irradiation power of a laser beam in accordance with a change in linear recording density are not carried out in the above-described conventional recording device.

Meanwhile, it is also conceivable to record, in advance, optimum irradiation power data of a laser beam with respect to the linear recording density and data related to the output level or intensity of a laser beam that is optimum for recording at a high rotational speed that is twice, four times or eight times the standard rotational speed of the magneto-optical disc, in a register provided in the recording device, and correct the irradiation power of a laser beam cast onto the magneto-optical recording medium in accordance with the optimum irradiation power with respect to the above-described intrinsic physical characteristics of the magneto-optical recording medium, the data related to the output level or intensity of a laser beam that is optimum with respect to the atmospheric temperature in the device, and the data related to the output level or intensity of a laser beam that is optimum for recording at a high rotational speed that is twice, four times or eight times the standard rotational speed.

By doing so, the quantity of data for correcting the output level or intensity of a laser beam, stored in advance in the register, is increased and the design of firmware as a program for correcting the output level or intensity of a laser beam on the basis of the correction data read out from the register is complicated.

### DISCLOSURE OF THE INVENTION

Thus, it is an object of the present invention to provide a recording and/or reproducing device and a recording and/or reproducing method using a recordable optical disc which are new and enable solution of the problem in a recording and/or reproducing device using an optical disc as a recording medium, like the conventional magneto-optical recording device or the like as described above.

It is another object of the present invention to provide a recording and/or reproducing device and a recording and/or reproducing method using a recordable optical disc as a recording medium which enable, with a simple structure, optimization of the irradiation power of a laser beam cast onto the optical disc in accordance with a change in rotational speed of the optical disc and a difference in linear recording density of recording tracks provided on the optical disc, quick and accurate recording of information, and reproduction of accurately recorded information.

In order to achieve the foregoing objects, a recording and/or reproducing device using an optical disc as a recording medium according to the present invention comprises: a head unit for casting at least a laser beam onto a recordable optical disc having a management data area in which at least data related to intrinsic physical characteristics and data related to linear recording density are recorded and a data recording area in which recording data is recorded, and thus carrying out recording to the optical disc and reading out data recorded on the optical disc; a rotational driving unit adapted for rotationally driving the optical disc and having a speed detection unit for detecting the rotational speed of the optical disc; a temperature detection unit for detecting the temperature on the periphery of the optical disc; and a control unit for calculating optimum power of a laser beam cast on the optical disc on the basis of the data related to intrinsic physical characteristics and the data related to linear recording density read out by the head unit, detection data from the speed detection unit, and detection data from the temperature detection unit, and controlling the head unit on the basis of the result of the calculation.

In this case, the control unit calculates the optimum power of a laser beam using a function F expressed by

F=K1·F1·F2·F3·F4+K2

where F1 represents a first function using the data related to intrinsic physical characteristics as a variable, F2 represents a second function using the detection data from the temperature detection unit as a variable, F3 represents a third function using the detection data from the speed detection unit as a variable, F4 represents a fourth function using the data related to linear recording density, and K1, K2 represent constants.

A recording and/or reproducing method for a recordable optical disc according to the present invention comprises the steps of: casting a laser beam onto a recordable optical disc having a management data area in which at least data related to intrinsic physical characteristics and data related to linear recording density are recorded and a data recording area in which recording data is recorded, and thus reading out the data related to intrinsic physical characteristics and the data related to linear recording density from the optical disc; detecting the rotational speed of the optical disc; and detecting the temperature on the periphery of the optical disc. The recording and/or reproducing method also comprises the steps of calculating optimum power of a laser beam cast on the optical disc on the basis of the read-out data related to intrinsic physical characteristics, the read-out data related to linear recording density, data related to the detected rotational speed and data related to the detected temperature, and controlling the output of the laser beam on the basis of the result of the calculation, thus performing recording to or reproduction from the optical disc.

The other objects of the present invention and specific advantages provided by the present invention will be further clarified by the following description of an embodiment with reference to the drawings.

### BRIEF DESCRIPTION OF THE DRAWINGS

FIG. 1 is a block diagram showing a recording/reproducing device using a magneto-optical disc as a recording medium according to the present invention.

FIG. 2 is a graph showing the relation between intrinsic physical characteristics of a magneto-optical disc used in the recording/reproducing device using a magneto-optical disc as a recording medium according to the present invention and optimum power of a laser beam cast onto the magneto-optical disc.

FIG. 3 is a graph showing the relation between the atmospheric temperature in the recording/reproducing device and optimum power of a laser beam cast onto the magneto-optical disc.

FIG. 4 is a graph showing the relation between the linear velocity of the rotationally driven magneto-optical disc and optimum power of a laser beam cast onto the magneto-optical disc.

FIG. 5 is a graph showing the relation between the linear recording density of the magneto-optical disc and optimum power of a laser beam cast onto the magneto-optical disc.

### BEST MODE FOR CARRYING OUT THE INVENTION

Hereinafter, as a recording and/or reproducing device for an optical disc to which the present invention is applied, an exemplary recording/reproducing device using a recordable magneto-optical disc as a recording medium will be described.

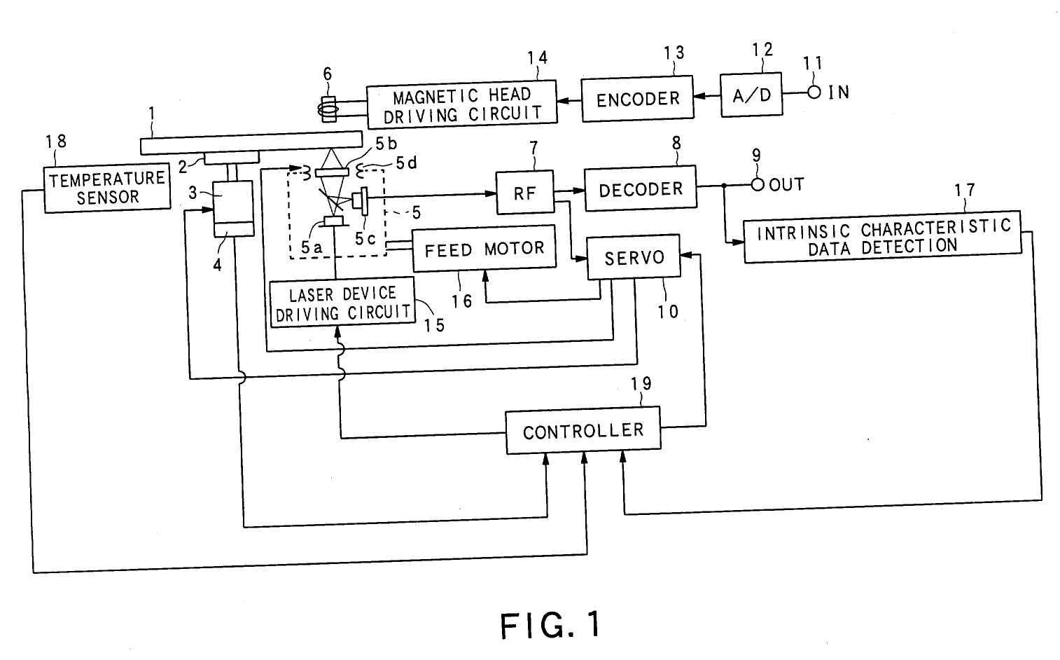

A magneto-optical disc 1, on which information can be recorded and which is used as a recording medium in a recording/reproducing device shown in FIG. 1 to which the present invention is applied, is constituted by a substrate, a magneto-optical recording layer as a recording layer, and a protection layer. The substrate is formed in a disc-shape by injection-molding of an optically transparent synthetic resin material such as polycarbonate. A center hole is provided at the center of the substrate. On one side of this substrate, a recessed and protruding pattern of a stamper provided in an injection molding machine, that is, pre-grooves meandering in a radial direction of the magneto-optical disc 1 on the basis of address data and pits based on data necessary for recording or reproduction, of the magneto-optical disk 1 used in this invention, are formed. The magneto-optical recording layer is deposited on the one side of the substrate where the recessed and protruding pattern is provided. The protection layer is for protecting the magneto-optical recording layer and is provided on the magneto-optical recording layer by using an ultraviolet-hardening resin.

On the magneto-optical disc 1, a lead-in area, a data recording area, and a lead-out area are provided. The lead-in area includes a TOC area as a management data area where TOC (table of contents) data is recorded. The TOC data recorded in the TOC area includes address data and end data indicating the start position of the data recording area, data indicating the position of a start address or the like of the lead-out area, data necessary for recording or reproduction, identification data indicating that this disc is a magneto-optical disc, and so on. The data necessary for recording includes data indicating intrinsic physical characteristics, data indicating the linear recording density, data indicating the standard output level or intensity of a laser beam at the time of recording, and so on, which will be described later. The data necessary for reproduction includes start address data indicating the start position of each of a plurality of data recorded in the data recording area, end address data indicating the end position thereof, and so on.

Recording to or reproduction from the magneto-optical disc 1 is carried out by the magneto-optical disc recording/reproducing device shown in FIG. 1.

The recording/reproducing device shown in FIG. 1 is constituted by a rotational driving unit for rotationally driving the magneto-optical disc 1, a head unit, a servo circuit unit, a reproduction signal processing unit, a recording signal processing unit, a controller and the like.

The rotational driving unit is made up of a disc table 2, a spindle motor 3, and a speed detection unit 4. The disc table 2 has an engagement part, not shown, to be engaged with the center hole of the magneto-optical disc 1, and a setting part on which the magneto-optical disc 1 is set. The disc table 2 is mounted at the distal end of the rotary shaft of the spindle motor 3. The spindle motor 3 rotationally drives the disc table 2, that is, the magneto-optical disc set on the disc table 2, at a constant linear velocity. The speed detection unit 4 is adapted for indirectly detecting the rotational speed of the magneto-optical disc 1 by detecting the rotational speed of the spindle motor 3, and is made up of a frequency generator, a photosensor and the like. Detection output data from the speed detection unit 4 is supplied to the controller, which will be described later.

The head unit is made up of an optical pickup 5 and a magnetic head 6. The optical pickup 5 is arranged on the side opposite to the substrate of the magneto-optical disc 1, and the magnetic head 6 is arranged to face the optical pickup 5 with the magneto-optical disc 1 held between them. The optical pickup 5 and the magnetic head 6 are connected with each other by a connection mechanism, not shown. When the optical pickup S is moved in a radial direction of the magneto-optical disc 1 by a feed mechanism using a feed motor as a driving source, which will be described later, the magnetic head 6 is also moved in the radial direction of the magneto-optical disc 1.

The optical pickup 5 is made up of a semiconductor laser device 5a as a light source, an objective lens 5b, a photodetector 5c, an actuator 5d, and optical components constituting an optical system together with the objective lens 5b.

A laser beam emitted from the semiconductor laser device 5a is focused on the magneto-optical recording layer of the magneto-optical disc 1 by the objective lens 5b. The laser beam reflected by the magneto-optical recording layer of the magneto-optical disc 1 becomes incident on the optical pickup 5 via the objective lens 5b again, and it is received and detected by the photodetector 5c. The objective lens 5b is supported by the actuator 5d so as to be displaceable in the direction of optical axis of the objective lens 5b, that is, a focusing direction, and in a planar direction orthogonal to the optical axis of the objective lens 5b, that is, a tracking direction. The actuator 5d is constituted by an electromagnetic actuator made up of, for example, a coil mounted on a bobbin on which the objective lens 5b is mounted and a permanent magnet provided to face the coil. The actuator 5d displaces the objective lens 5b in the focusing direction and the tracking direction on the basis of a focusing servo signal and a tracking servo signal supplied from the servo circuit, which will be described later.

The magnetic head 6 is made up of a coil and a yoke, and applies a vertical magnetic field as an external magnetic field modulated on the basis of data to be recorded on the magneto-optical disc 1.

An output signal from the photodetector 5c of the optical pickup 5 is supplied to the reproduction signal processing unit. The reproduction signal processing unit is constituted by an RF amplifier 7 and a decoder 8. The RF amplifier 7 is supplied with the output signal from the photodetector 5c of the optical pickup 5, then amplifies the output signal from the photodetector 5c and generates various signals. For example, the RF amplifier 7 generates an RF signal as a read-out signal obtained by reading out data recorded on the magneto-optical disc 1 on the basis of the output signal from the photodetector 5c and also generates a focusing error signal and a tracking error signal.

The RF signal outputted from the RF amplifier 7 is supplied to the decoder 8. The decoder 8 performs decoding processing on the supplied RF signal. The decoding processing performed by the decoder 8 includes demodulation processing corresponding to modulation processing performed by an encoder, which will be described later, at the time of recording, and error detection and error correction processing based on an added error correcting code. Output data from the decoder 8 is outputted from an output terminal 9 and is also supplied to an intrinsic characteristic data detection circuit, which will be described later.

The RF signal, the focusing error signal and the tracking error signal outputted from the RF amplifier 7 are supplied to a servo circuit 10, which constitutes the servo circuit unit.

The servo circuit 10 generates a focusing servo signal and a tracking servo signal on the basis of the focusing error signal and the tracking error signal supplied from the RF amplifier 7. The generated focusing servo signal and tracking servo signal are supplied to the actuator 5d, and the objective lens 5b is thus displaced in the focusing direction and the tracking direction. As a result, focusing servo and tracking servo are carried out.

The servo circuit 10 extracts a clock signal from the RF signal supplied from the RF amplifier 7, then detects a phase difference between the extracted clock signal and a reference clock signal, and generates a spindle servo signal on the basis of the detected phase difference. The generated spindle servo signal is supplied to the spindle motor 3. As a result, the spindle motor 3 rotates at a constant linear velocity on the basis of the supplied spindle servo signal. Spindle servo is thus carried out.

Meanwhile, a recording signal to be recorded on the magneto-optical disc 1 is inputted from an input terminal 11 and supplied to the recording signal processing unit. The recording signal processing unit is constituted by an analog-to-digital (A/D) converter circuit 12 and an encoder 13.

The A/D converter circuit 12 digitally converts the recording signal inputted from the input terminal 11 and supplied the digital signal to the encoder 13. The encoder 13 performs error correction coding processing based on the error correcting code on the digital signal supplied from the A/D converter circuit 12 and then performs modulation processing. The error correcting code used for the error correction coding processing performed by the encoder 13 is, for example, CIRC (Cross Interleave Reed-Solomon Code). The modulation processing performed by the encoder 13 is, for example, modulation processing based on an 8-18 modulation system.

The recording data as output data outputted from the encoder 13 is supplied to a driving circuit 14 of the magnetic head. A driving signal based on the recording data supplied from the driving circuit 14 is supplied to the magnetic head 6. As a result, a vertical magnetic field based on the supplied driving signal, that is, based on the recording data, is applied to the magneto-optical disc 1 from the magnetic head 6.

In this case, a laser beam having a level or intensity necessary for recording is emitted from the semiconductor laser device 5a of the optical pickup 5 and is cast onto the magneto-optical disc 1. The semiconductor laser device 5a is driven on the basis of a driving signal supplied from a driving circuit 15 of the semiconductor laser device. From the semiconductor laser device 5a, a laser beam having an output level or intensity which varies between recording to and reproduction from the magneto-optical disc 1 is emitted on the basis of the driving signal from the driving circuit 15. The driving signal is outputted from the driving circuit 15 on the basis of a control signal supplied from the controller, which will be described later, so that the output level or intensity in recording is higher than the output level or intensity in reproduction.

The servo circuit 10 generates a feed motor driving signal on the basis of a low-frequency component of the tracking error signal supplied from the RF amplifier 7. The generated feed motor driving signal is supplied to the feed motor 16. The feed motor 16 functions as a driving source to move the head unit made up of the optical pickup 5 and the magnetic head 6, in the radial direction of the magneto-optical disc 1. The feed mechanism moves the head unit from a predetermined position on the inner circumferential side or outer circumferential side of the magneto-optical disc 1 to the outer circumferential side or inner circumferential side on the basis of a control signal from the controller, which will be described later.

The output data from the decoder 8 is supplied to the intrinsic characteristic data detection circuit 17, as described above. This intrinsic characteristic data detection circuit 17 extracts and detects eigenvalue data included in TOC data read out from the TOC data area of the magneto-optical disc 1, that is, intrinsic data of the magneto-optical disc 1 indicating the composition of a recording material constituting the magneto-optical recording layer of the magneto-optical disc, the thickness of the layer and the like, and data related to the linear recording density of the magneto-optical disc 1. The eigenvalue data and the data related to the linear recording density from the intrinsic characteristic data detection circuit 17 are supplied to the controller, which will be described later.

In the recording/reproducing device shown in FIG. 1, a temperature sensor 18 is provided. In the recording/reproducing device, the temperature sensor 18 is provided near the magneto-optical disc 1 set on the disc table 2. An output signal from the temperature sensor 18 is supplied to the controller, which will be described later.

The controller 19 is constituted by a microcomputer and controls the operation of the whole recording/reproducing device shown in FIG. 1. The controller 19 generates correction data for the output level or intensity of a laser beam cast from the semiconductor laser device 5a, which will be described later, on the basis of the output signal from the speed detection unit 4, the intrinsic data and the data related to the linear recording density from the intrinsic characteristic data detection circuit 17 and the output signal from the temperature sensor 18, and thus performs output control. In addition to this output control, the controller 19 is connected with an operating unit made up of a plurality of operating switches, not shown, and causes various operations other than a recording or reproducing operation of the recording/reproducing device on the basis of an input signal from the operating unit. For example, in the case of carrying out recording or reproduction from a predetermined position in the recording area of the magneto-optical disc 1 on the basis of an input signal from the operating unit, the controller 19 supplies a control signal to the servo circuit 10 to stop supplying a tracking servo signal to the actuator 5d and also supplies a control signal to the feed motor 16 to move the optical pickup 5 and the magnetic head 6 in the radial direction of the magneto-optical disc 1 using the feed mechanism. In this case, the controller 19 is supplied with address data read out from the magneto-optical disc 1 and performs the above-described operation to move the optical pickup 5 and the magnetic head 6 by the feed mechanism on the basis of the supplied address data. The address data is recorded by meandering of the pre-grooves formed on the magneto-optical disc 1 in the radial direction of the magneto-optical disc 1. Therefore, the meandering component of the pre-grooves is extracted from the output signal of the photodetector 5c of the optical pickup 5 and the extracted signal component is obtained.

Meanwhile, in the present invention, the intrinsic physical characteristics of the manufactured magneto-optical disc 1 such as the composition and thickness of the recording layer and the material of the protection film vary, depending on a manufacturing device and manufacturing steps, a master board, a mother board, a stamper, and transfer processing used in the process of manufacturing the magneto-optical disc 1 as a target of information recording. An optimum output level or intensity (hereinafter referred to as optimum power value) P0 of a laser beam to the magneto-optical disc 1 from the semiconductor laser device 5a is actually measured in advance on the basis of theoretical analysis.

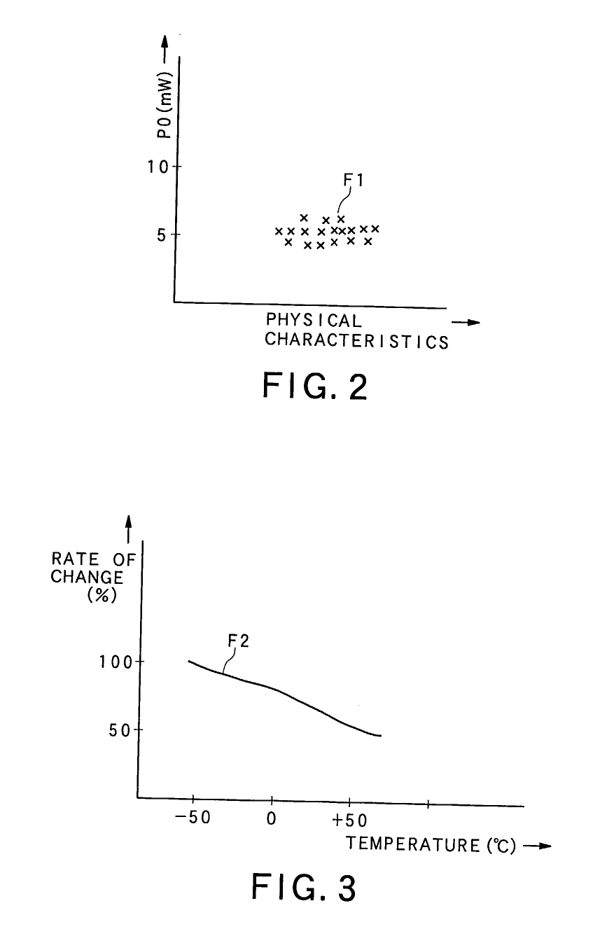

As a result of the actual measurement, the relation between the intrinsic physical characteristics of the magneto-optical disc 1 and the optimum power value P0 of a laser beam from the semiconductor laser device 5a is found to be as shown in FIG. 2. The result of the actual measurement shown in FIG. 2 can be expressed as a function F1. In the present invention, the intrinsic physical characteristic data of the actual measurement or theoretical analysis using some of the manufactured magneto-optical discs 1 as samples is recorded as one of TOC data in the lead-in area of the magneto-optical disc 1, as described above. On the other hand, the function F1 between the optimum power value P0 and the intrinsic physical characteristic data as shown in FIG. 2 is stored in a memory of the controller 19.

In the recording/reproducing device shown in FIG. 1, when the ambient atmospheric temperature of the magneto-optical disc 1 at the time of recording varies, that is, when the temperature within the recording/reproducing device shown in FIG. 1 vanes, this variance in atmospheric temperature causes changes in optimum power value of a laser beam from the semiconductor laser device 5a. Therefore, the optimum power value of a laser beam emitted from the semiconductor laser device 5a must be corrected.

Meanwhile, it is theoretically found that when the atmospheric temperature of the magneto-optical disc 1 in the recording/reproducing device changes from normal temperatures with respect to the optimum power value of a laser beam from the semiconductor laser device 5a, the optimum power value must be corrected by (−0.2 to 1%)/° C., compared with the optimum power value in the case of normal temperatures. A function F2 representing the rate of correction change, thus led out, of the optimum power value of a laser beam from the semiconductor laser device 5a with respect to the atmospheric temperature is as shown in FIG. 3.

In the present invention, data of the function F2 representing the rate of correction change for correcting the optimum laser beam from the semiconductor laser device 5a with respect to changes in atmospheric temperature within the device of the magneto-optical disc 1 at the time of recording is led out in advance by actual measurement or calculation, and the data related to the correction function F2, thus led out, is stored in the memory of the controller 19 in advance.

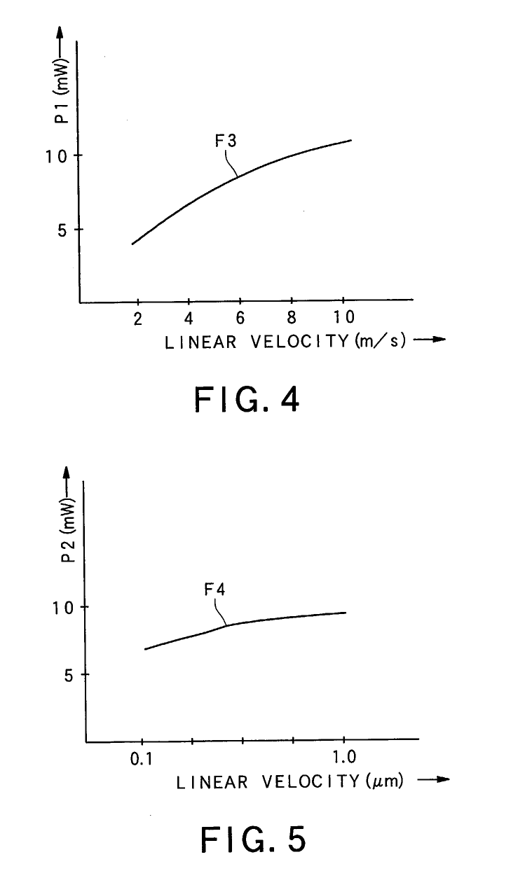

In the present invention, the linear velocity of the magneto-optical disc 1 at the time of recording and an optimum lower value P1 of a laser beam from the semiconductor laser device 5a are actually measured in advance on the basis of theoretical analysis. As result, a function F3 between the resulting linear velocity and the optimum power value P1 of a laser beam is found to be as shown in FIG. 4. Function data of the optimum power value P1 corresponding to the linear velocity, represented by the function F3 shown in FIG. 4, is stored in the memory of the controller 19 in advance.

Moreover, in the present invention, the relation between a linear recording density giving a change of ±20% to the linear velocity of the magneto-optical disc 1 and an optimum power value P2 of a laser beam from the semiconductor laser device is actually measured and led out on the basis of theoretical analysis. As a result, a function F4 between the linear velocity, thus found, and the optimum power value P2 of a laser beam from the semiconductor laser device 5a is found to be as shown in FIG. 5.

In the present invention, the linear recording density data is recorded in advance as one of TOC data in the lead-in area of the magneto-optical disc 1, and function data of the optimum power value P2 of a laser beam from the semiconductor laser device 5a corresponding to the linear recording density data is stored in the memory of the controller 19 in advance.

In the present invention, a combined function F for calculating the optimum power value of a laser beam from the semiconductor laser device 5a, on the basis of the function F1, the function F2, the function F3 and the function F4 using the intrinsic characteristic data of the magneto-optical disc 1, the ambient atmospheric temperature of the magneto-optical disc 1, the linear velocity of the magneto-optical disc 1 and the linear recording density on the periphery of the magneto-optical disc 1 as their respective variables, is led out in advance on the basis of theoretical analysis, as expressed by the following equation (1), where K1, K2 are constants. The resulting combined function F is stored in the memory of the controller 19 in advance.

F=K1·F1·F2·F3·F4+K2 (1)

The recording operation of the recording/reproducing device of FIG. 1 constituted as described above will now be described.

First, to carry out the recording operation, the magneto-optical disc 1 is directly set on the disc table 2 by a carrier mechanism, not shown, provided in the recording/reproducing device shown in FIG. 1 or by a user. In this case, the magneto-optical disc 1 is positioned on the disc table as the center hole of the magneto-optical disc 1 is engaged with the engagement part provided on the disc table.

A recording operation switch of the operating unit, not shown, is operated by the user and an input signal indicating the start of recording is supplied to the controller 19. The controller 19 activates the spindle motor 3 to start rotating the magneto-optical disc 1 and supplies a control signal to the servo circuit 10 to move the objective lens 5b in the focusing direction, thus carrying out a focusing servo lead-in operation. In this case, the controller 19 supplies a control signal to the driving circuit 15 to cause the semiconductor laser device 5a to emit a laser beam having an output level or intensity necessary for reproduction.

On completion of the focusing servo lead-in operation, the servo circuit 10 closes a focusing servo loop, then carries out a tracking servo lead-in operation, and closes a tracking servo loop. Although various methods are proposed as methods for closing a focusing servo loop and for closing a tracking servo loop, these methods are not particularly related with the present invention and therefore will not be described in detail.

When the focusing servo loop and the tracking servo loop are closed, an output signal as a read-out signal of the magneto-optical disc 1 is obtained by the optical pickup 5. That is, an RF signal is obtained from the RF amplifier 7. The servo circuit 10 detects the phase of a synchronizing signal of the RF signal from the RF amplifier 7, then synchronizes a clock signal from a clock generator provided on the device side, extracts the clock signal, and carries out spindle servo of the spindle motor 3.

Until the RF signal is obtained from the RF amplifier 7, the servo circuit 10 may control the driving of the spindle motor 3 on the basis of the speed detection unit.

When the above-described start-up operation for recording on the magneto-optical disc 1 is completed, the controller 19 supplies a control signal to the feed motor 16 to move the optical pickup 5 toward the inner circumferential side of the magneto-optical disc 1. More precisely, it causes the feed motor 16 to move the optical pickup 5 to a position facing the TOC area provided on the inner circumferential side of the magneto-optical disc 1.

The optical pickup 5, moved to the position facing the TOC area of the magneto-optical disc 1, reads TOC data recorded in the TOC area of the magneto-optical disc 1. An output signal from the optical pickup 5, that is, an output signal from the photodetector 5c, is supplied to the RF amplifier 7. The RF amplifier 7 generates a focusing error signal and a tracking error signal and also generates an RF signal on the basis of the output signal from the photodetector 5c, as described above. The generated RF signal is supplied to the decoder 8. The decoder 8 performs decoding processing such as demodulation processing, error detection processing and error correction processing on the RF signal supplied thereto.

Intrinsic physical characteristic data is detected and extracted from output data from the decoder 8, that is, the TOC data, by the intrinsic characteristic data detection circuit 17, and is supplied to the controller 19. Data indicating the linear recording density in the TOC data, that is, linear recording density data, is also supplied to the controller 19. At this point, the controller 19 is supplied with an output signal from the temperature sensor 18 and an output signal from the speed detection unit 4.

The controller 19 reads out, from its memory, function data F1(D) of the optimum power value P0 of a laser beam corresponding to intrinsic physical characteristic data D detected by the intrinsic characteristic data detection circuit 17 and also reads out, from its memory, correction function data F2(Ta) of the optimum power value of a laser beam corresponding to an atmospheric temperature Ta detected by the temperature sensor 18. Similarly, function data F3(VL) of the optimum power value of a laser beam corresponding to a rotational speed VL detected by the speed detection unit 4 is read out from the memory and function data F4(LD) of the optimum power value P2 of a laser beam corresponding to linear recording density data LD of the magneto-optical disc 1 extracted from the TOC data of the magneto-optical disc 1 is read out from the memory.

The controller 19 calculates the following equation (2) based on the above-described equation (1), thereby calculating the combined function F for finding the optimum power value of a laser beam from the semiconductor laser device 5a.

F=K1·F1(D)·F2(Ta)·F3(VL)·F4(LD)+K2 (2)

A recording signal to be recorded to the magneto-optical disc 1 is inputted from the input terminal 11. The recording signal inputted from the input terminal 11 is converted to a digital signal by the A/D converter circuit 12. The digital signal outputted from the A/D converter circuit 12 is supplied to the encoder 13, where encoding processing such as error correction coding processing and modulation processing is performed. Recording data as output data from the encoder 13 is supplied to the driving circuit 14. The magnetic head 6 applies a vertical magnetic field as an external magnetic field to the magneto-optical disc 1 on the basis of a driving signal from the driving circuit 14.

At this point, a laser beam having the output level or intensity calculated on the basis of the above-described combined function F, that is, a laser beam having the optimum power value, is cast onto the magneto-optical disc 1 from the semiconductor laser device 5a. In other words, a laser beam having the output level or intensity necessary for recording is cast thereto.

As a result, the part irradiated with the laser beam, of the magneto-optical recording layer of the magneto-optical disc 1, is heated to, for example, not less than the Curie temperature by the laser beam, and after that, when the temperature is lowered from the Curie temperature, this part is magnetized along the direction of the external magnetic field applied by the magnetic head 6. In this case, as the feed motor 16 is driven, the optical pickup 5 is moved together with the magnetic head 6 to a recording start position in the data recording area of the magneto-optical disc 1 by the feed mechanism.

When the temperature within the recording/reproducing device is raised by the start of the recording operation, the output signal from the temperature sensor 18 changes because of the temperature rise. Therefore, the controller 19 recalculates the above-described combined function F and corrects the optimum power value of the laser beam. The output signal from the temperature sensor 18 is periodically taken into the controller 19 and the optimum power value of the laser beam is corrected by the controller 19.

In the case of carrying out recording to the magneto-optical disc 1 at a speed that is higher than, for example, twice a standard linear velocity of 1.2 m/sec of the magneto-optical disc 1, the controller 19 rotationally drives the spindle motor 3 at a linear velocity that is twice the standard speed, for example, and changes the output level or intensity of a laser beam from the semiconductor laser device 5a. The controller 19 calculates the above-described combined function F on the basis of an output signal from the speed detection unit 4 and thus corrects the optimum power value of the laser beam.

As described above, in the present invention, the intrinsic physical characteristic data and the linear recording density data of the magneto-optical disc 1 are detected from the TOC data of the magneto-optical disc 1 by the intrinsic characteristic data detection circuit 17, and the atmospheric temperature on the periphery of the magneto-optical disc 1 is detected by the temperature sensor 18. The respective detection signals are supplied to the controller 19. The function data F1(D) of the optimum power value P0 of the laser beam, the function data F4(LD) of the optimum power value P2 of the laser beam, the function data F3(VL) of the optimum power value of the laser beam, and the correction function F2(Ta) of the optimum power value of the laser beam, which correspond to the intrinsic physical characteristic data, the linear recording density data, the data related to the rotational speed of the magneto-optical disc 1, and the data related to the atmospheric temperature, respectively, are read out by the controller 19 from its memory.

The controller 19 can calculate the optimum power value of the laser beam quickly and accurately, by using the combined function F for calculating the optimum power value of the laser beam from the semiconductor laser device 5a using the intrinsic physical characteristic data, the data related to the temperature, the data related to the rotational speed and the data related to the linear recording density of the magneto-optical disc 1 as variables, that is, the above-described equation (1). As a result, increase in quantity of data in the memory of the controller 19 is prevented and no complicated design is necessary for the firmware. With a simple structure, the optimum power value of the laser beam can be set quickly and accurately, corresponding to the intrinsic physical characteristics of the magneto-optical disc 1, the atmospheric temperature at the time of recording, the linear velocity of the magneto-optical disc 1, and the linear recording density of the recording track of the magneto-optical disc 1. Thus, information of high quality can be recorded to the magneto-optical disc 1.

The recording operation of the recording/reproducing device shown in FIG. 1 is described above. Also in the reproducing operation, the optimum power value of a laser beam can be similarly corrected and set.

In the reproducing operation of the recording/reproducing device, when a reproducing operation switch of the operating unit, not shown, is operated by the user, a start-up operation similar to that in the recording operation is carried out and the controller 19 supplies a control signal to the feed motor 16 to move the optical pickup 5 to a position facing the TOC area of the magneto-optical disc 1.

TOC data read out from the TOC area of the magneto-optical disc 1 by the optical pickup 5 is processed as in the recording operation and then taken into the controller 19. The TOC data supplied to the controller 19 includes data necessary for reproduction from the magneto-optical disc 1 such as start address data indicating the start positions of a plurality of data already recorded on the magneto-optical disc 1 and end address data indicating the end positions of these data, as well as intrinsic physical characteristic data and linear recording density data.

The controller 19 reads out, from the magneto-optical disc 1, data designated by an input signal inputted from the operating unit on the basis of the supplied TOC data. That is, the controller 19 supplies a control signal to the feed motor 16 to move the optical pickup 5 to a position where the data designated by the operating unit is recorded, in the recording area of the magneto-optical disc 1.

An output signal from the optical pickup 5 moved to the predetermined position on the magneto-optical disc 1, that is, an output signal from the photodetector 5c, is supplied to the RF amplifier 7. The RF amplifier 7 generates a focusing error signal and a tracking error signal on the basis of the output signal supplied thereto and also generates an RF signal.

The focusing error signal and the tracking error signal generated by the RF amplifier 7 are supplied to the servo circuit 10. The servo circuit 10 generates a focusing servo signal and a tracking servo signal based on the focusing error signal and the tracking error signal supplied thereto. The generated focusing servo signal and tracking servo signal are supplied to the actuator 5d, thus carrying out focusing servo and tracking servo.

The RF signal from the RF amplifier 7 is supplied to the decoder 8. The decoder 8 performs decoding processing on the supplied RF signal such as demodulation processing, error detection and error correction processing. Output data from the decoder 8 is outputted from the output terminal 9.

Since the temperature within the recording/reproducing device is changed by the reproducing operation, the controller 19 calculates and corrects the optimum power value of a laser beam from the semiconductor laser device 5a by using the combined function F expressed by the equation (1) on the basis of an output signal from the temperature sensor 18.

In this manner, in the reproducing operation of the recording/reproducing device, the optimum power value of the laser beam can be corrected similarly to the recording operation.

In the above description, the recording/reproducing device using a magneto-optical disc as a recording medium is explained as an example. However, the present invention can also be applied to a recording/reproducing device which uses a recordable optical disc other than a magneto-optical disc, for example, a phase-change type optical disc or a write-once type optical disc using organic dye, and similar advantages to those of the above-described recording/reproducing device using a magneto-optical disc can be provided.

Industrial Applicability

According to the present invention, a laser beam is cast onto a recordable optical disc having a management data area in which at least data related to intrinsic physical characteristics of the optical disc and data related to linear recording density are recorded and a data recording area in which recording data is recorded, and the data related to intrinsic physical characteristics and the data related to linear recording density are thus read out from the optical disc. The rotational speed of the optical disc and the temperature on the periphery of the optical disc are detected, and optimum power of a laser beam cast on the optical disc is calculated on the basis of the read-out data related to intrinsic physical characteristics, the read-out data related to linear recording density, data related to the detected rotational speed and data related to the detected temperature. The output of the laser beam is controlled on the basis of the result of calculation. Therefore, recording to or reproduction from the optical disc is carried out while irradiating the optical disc with a laser beam having optimum power value corresponding to the environment of the optical disc and device and the operating status of recording/reproduction. Thus, quick and accurate recording of information and accurate reproduction of information can be carried out.

1. A recording and/or reproducing device for a recordable optical disc comprising:
a head unit for casting at least a laser beam onto a recordable optical disc having a management data area in which at least data related to intrinsic physical characteristics and data related to linear recording density are recorded and a data recording area in which recording data is recorded, and thus carrying out recording to said optical disc and reading out data recorded on said optical disc;
a rotational driving unit adapted for rotationally driving said optical disc and having a speed detection unit for detecting the rotational speed of said optical disc;
a temperature detection unit for detecting the temperature on the periphery of said optical disc; and
a control unit for calculating optimum power of a laser beam cast onto said optical disc on the basis of said data related to intrinsic physical characteristics and said data related to linear recording density read out by said head unit, detection data from said speed detection unit, and detection data from said temperature detection unit, and controlling said head unit on the basis of the result of said calculation.

2. The recording and/or reproducing device for a recordable optical disc as claimed in claim 1, wherein said control unit calculates the optimum power of said laser beam on the basis of a function using said data related to intrinsic physical characteristics, said data related to linear recording density, the detection data from said speed detection unit, and the detection data from said temperature detection unit, as variables.

3. The recording and/or reproducing device for a recordable optical disc as claimed in claim 2, wherein said control unit calculates the optimum power of said laser beam using a function F expressed by
F=K1·F1·F2·F3·F4+K2
where F1 represents a first function using said data related to intrinsic physical characteristics as a variable, F2 represents a second function using the detection data from said temperature detection unit as a variable, F3 represents a third function using the detection data from said speed detection unit as a variable, F4 represents a fourth function using said data related to linear recording density, and K1, K2 represent constants.

4. The recording and/or reproducing device for a recordable optical disc as claimed in claim 1, further comprising a reproduction signal processing unit for performing signal processing for reproduction on an output signal from said head unit, and an intrinsic data detection unit for detecting said data related to intrinsic physical characteristics from output data from said reproduction signal processing unit and supplying said data related to intrinsic physical characteristics to said control unit.

5. A recording and/or reproducing method for a recordable optical disc comprising the steps of:
casting a laser beam onto a recordable optical disc having a management data area in which at least data related to intrinsic physical characteristics and data related to linear recording density are recorded and a data recording area in which recording data is recorded, and thus reading out said data related to intrinsic physical characteristics and said data related to linear recording density from said optical disc;
detecting the rotational speed of said optical disc;
detecting the temperature on the periphery of said optical disc; and
calculating optimum power of a laser beam cast onto said optical disc on the basis of said read-out data related to intrinsic physical characteristics, said read-out data related to linear recording density, data related to said detected rotational speed and data related to said detected temperature, and controlling the output of said laser beam on the basis of the result of said calculation.

6. The recording and/or reproducing method for a recordable optical disc as claimed in claim 5, wherein the optimum power of said laser beam is calculated on the basis of a function using said data related to intrinsic physical characteristics, said data related to linear recording density, the data related to said detected rotational speed and the data related to said detected temperature, as variables.

7. The recording and/or reproducing method for a recordable optical disc as claimed in claim 6, wherein the optimum power of said laser beam is calculated using a function F expressed by
F=K1·F1·F2·F3·F4+K2
where F1 represents a first function using said data related to intrinsic physical characteristics as a variable, F2 represents a second function using the data related to said detected temperature as a variable, F3 represents a third function using the data related to said detected rotational speed as a variable, F4 represents a fourth function using said data related to linear recording density, and K1, K2 represent constants.
